(19) United States
(12) Patent Application Publication
(10) Pub. No.: US 2006/0001820 A1
(43) Pub. Date: Jan. 5, 2006

(54) LIQUID CRYSTAL MODULE

(76) Inventors: Yin-Tsung Cheng, Yun-Lin Hsien (TW); Po-Cheng Shih, Taipei City (TW); Hsin-Yuan Chuang, Ping-Tung Hsien (TW); Han-Ping Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/904,379

(22) Filed: Nov. 7, 2004

(30) Foreign Application Priority Data
Jul. 5, 2004 (TW) 093120167

(51) Int. Cl. G02F 1/1345

(52) U.S. Cl. 349/150

(57) ABSTRACT

A liquid crystal module includes a plate, a plurality of driving circuits formed on the plate, at least an opening formed on the back of the plate, a connector positioned in the opening, and a plurality of flexible circuit boards used to connect the driving circuits and the connector.

### BACKGROUND OF INVENTION

1. Field of the Invention

The present invention relates to a liquid crystal module, and more particularly, to a liquid crystal module applied in a portable panel.

2. Description of the Prior Art

A flexible circuit board is flexible to reduce the space for installing the circuit board and is widely applied to various electronic products, especially to portable electronic products, such as cellular phones, digital cameras, portable VCD/DVD or vehicle displays. The flexible circuit board functions as a connector between different electronic devices, for example, the flexible circuit board connects a display panel to a signal control circuit so as to transmit image signals to the display panel and control the display thereon.

FIG. 1 is a schematic diagram of a conventional connecting design for a flexible circuit board. As shown in FIG. 1, a plate 10, such as an LCD panel, includes a display region 12 at the central part of the plate 10, a peripheral circuit region 14 at the edge of the plate 10, a plurality of gate driving circuits 16 formed at one side of the peripheral circuit region 14, a plurality of signal driving circuits 18 formed at another side of the peripheral circuit region 14, and a flexible circuit board 20 connected to the gate driving circuits 16 and the signal driving circuits 18.

The gate driving circuits 16 and the signal driving circuits 18 are connected to perpendicularly crossing scan lines and signal lines on the plate 10, so as to control signals along the X-direction and the Y-direction on the plate 10. Currently, the gate driving circuits 16 and the signal driving circuits 18 cannot be formed on the plate 10 by mass production due to technological constraints. Therefore, the gate driving circuits 16 and the signal driving circuits 18 are normally bonded onto the plate 10 using a tape carrier package (TCP) or by chip on glass (COG) technology. In addition, the gate driving circuits 16 and the signal driving circuits 18 are connected to a signal control circuit through flexible flat cables (FFC) 22 on the flexible circuit board 20, so as to transmit image signals from the signal control circuit to the corresponding signal lines and scan lines.

To reduce the thickness of a portable panel, the conventional connecting design for the flexible circuit board uses the flexible circuit board 20 of a long-bar piece to connect the gate driving circuits 16 and the signal driving circuits 18 to other electronic devices. The long-bar flexible circuit board contains a plurality of wire sets to connect to the corresponding driving circuits. Therefore, an accurate alignment between the flexible circuit board and the driving circuits is required when pasting the flexible circuit board onto the plate. In addition, the wire sets on the flexible circuit board are also required to be made with high precision to prevent a deviation or misalignment between the flexible circuit board and the corresponding driving circuits on the plate. However, the length of the flexible circuit board increases when the size of the display panel is enlarged. Especially for the display panel with size over 10 inches, the flexible circuit board is too long and extremely high precision is required, it is therefore limited to fabricate the flexible circuit board and to align the flexible circuit board to the driving circuits on the plate. As a result, the flexible circuit board becomes very expensive and has a great loss, thus being disadvantageous to develop and expand the application of the portable panel.

### SUMMARY OF INVENTION

It is therefore an object of the present invention to provide a liquid crystal module to reduce the cost for fabricating a portable panel and to increase the throughput.

According to one embodiment of the present invention, the liquid crystal module includes a plate, a plurality of driving circuits formed on the plate, at least an opening formed on the back of the plate, a connector positioned in the opening, and a plurality of flexible circuit boards for connecting the driving circuits to the connector.

It is an advantage of the present invention that the plurality of flexible circuit boards are connected to the corresponding driving circuits respectively. Therefore, the problems such as deviation or misalignment between the single piece of the conventional long-bar flexible circuit board and the driving circuits on the plate can be completely avoided. In addition, the precision requirement in either fabricating or pasting the flexible circuit boards onto the plate is more flexible and practicable, thereby reducing the cost for fabricating the portable panel and increasing the throughput thereof as well. Furthermore, the connector connects the flexible circuit boards, and the connector is installed inside the opening on the back of the plate. The depth of the opening compensates for the thickness of the connector, and the total thickness of the plate is thus not increased with the addition of the connector.

These and other objectives of the present invention will become apparent to those of ordinary skill in the art with reference to the following detailed description of the preferred embodiments illustrated in the various drawings.

### BRIEF DESCRIPTION OF DRAWINGS

FIG. 1 is a schematic diagram of a connecting design to a flexible circuit board according to the prior art;

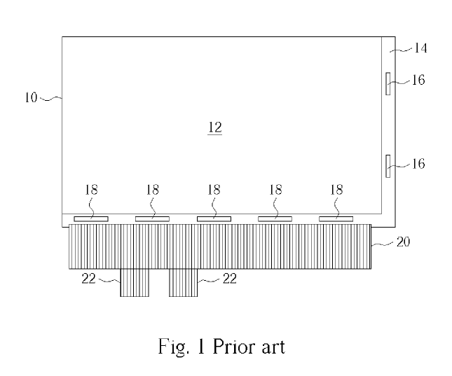

FIG. 2 is a schematic diagram of a liquid crystal module in a portable panel according to the present invention; and

FIG. 3 illustrates a back view of a portable panel according to the present invention.

### DETAILED DESCRIPTION

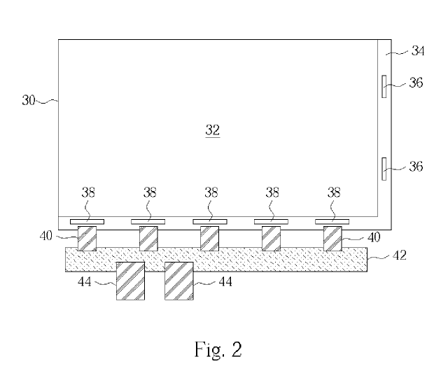

FIG. 2 is a schematic diagram of a connecting design for flexible circuit boards in a portable panel according to the present invention. As shown in FIG. 2, a plate 30 includes a display region 32 at the central part of the plate 30, a peripheral circuit region 34 at the edge of the plate 30, a plurality of gate driving circuits 36 formed at one side of the peripheral circuit region 34, a plurality of signal driving circuits 38 formed at another side of the peripheral circuit region 34, and a plurality of flexible circuit boards 40 connected to the gate driving circuits 36 and the signal driving circuits 38. In a better embodiment of the present invention, the plate 30 can be a portable panel, such as LCD panel, OLED panel or other flat display panels with middle or small size. The gate driving circuits 36 and the signal driving circuits 38 are connected to perpendicularly crossing scan lines and signal lines on the plate 30, so as to control signals along the X-direction and the Y-direction on the plate 30.

Each of the flexible circuit boards 40 includes a plurality of wires to connect to the corresponding gate driving circuit 36 and/or the corresponding signal driving circuit 38. The length of each flexible circuit board 40 is predetermined and not adjusted with the size of the plate 30 or the total numbers of the driving circuits 36 and 38. Therefore, the length of each flexible circuit board 40 is shorter than the conventional long-bar flexible circuit board and is able to prevent the problems of deviation or misalignment between the flexible circuit board and the driving circuits on the plate. In a better embodiment of the present invention, the flexible circuit board 40 can be a flexible printed circuit (FPC) board, a flexible copper clad laminate (FCCL), a tape carrier package (TCP) or in other flexible circuit designs. Besides, one end of the flexible circuit board 40 is connected to a connector 42, such as a printed circuit board (PCB) or other connecting circuits. Using the connector 42 and other flexible circuit boards 44 connected to the connector 42, the flexible circuit board 40 is electrically connected to a signal control circuit or other electronic devices.

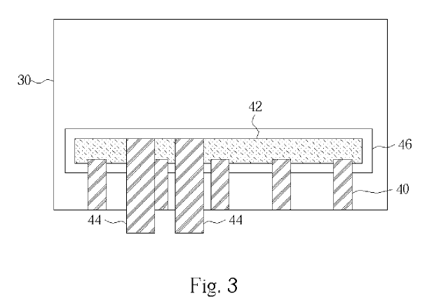

Referring to FIG. 3, it is a back view of a portable panel according to the present invention. As shown in FIG. 3, an opening 46 is formed on the back of the plate 30 to contain the connector 42, such that the thickness of the connector 42 is offset by the depth of the opening 46 to ensure the introduce of the connector 42 will not increase the total thickness of the entire panel. In a better embodiment of the present invention, the opening 46 can be an indentation or hole formed in an outer frame for packing the plate 30. In addition to contain the connector 42, the opening 46 further functions to balance the stress applied on the outer frame or the plate 30, preventing the outer frame from being distorted. The outer frame is either a metal frame or a plastic frame. In addition, the design of the opening 46, including the position, the size, the shape and the number, is optimized according to the stress sustainability or the sizes of the plate 30 and the connector 42.

Therefore, the problems such as deviation or misalignment between the single piece of the conventional long-bar flexible circuit board and the driving circuits on the plate can be completely prevented according to the present invention. According to one embodiment of the present invention, the connector that connects to the flexible circuit boards is installed inside the opening on the back of the plate. The depth of the opening compensates for the thickness of the connector, and thus the total thinness of the plate is not increased with the addition of the connector.

Those skilled in the art will readily observe that numerous modifications and alterations of the device and method may be made while utilizing the teachings of the invention.

What is claimed is:

1. A liquid crystal module, comprising:
a plate having a plurality of driving circuits and an opening formed on the back of the plate;
a connector deposed in the opening; and
a plurality of flexible circuit boards for connecting the plurality of driving circuits to the connector.

2. The liquid crystal module of claim 1, wherein the connector comprises a printed circuit board.

3. The liquid crystal module of claim 1, wherein the plate comprises a portable panel.

4. The liquid crystal module of claim 1, wherein the plurality of driving circuits comprise signal driving circuits.

5. The liquid crystal module of claim 1, wherein the plurality of driving circuits comprise gate driving circuits.

6. The liquid crystal module of claim 1, wherein the plurality of flexible circuit boards comprise a flexible printed circuit, a flexible copper clad laminate, or a tape carrier package.
